(19) United States
(12) Patent Application Publication
(10) Pub. No.: US 2015/0055736 A1
(43) Pub. Date: Feb. 26, 2015

(54) METHOD AND APPARATUS FOR DECODING RECEIVED SEQUENCE

(71) Applicants: THE REGENTS OF THE UNIVERSITY OF CALIFORNIA, Oakland, CA (US); Electronics and Telecommunications Research Institute, Daejeon (KR)

(72) Inventors: Seung-Hwan LEE, Daejeon (KR); Seok SEO, Daejeon (KR); Jae Su SONG, Daejeon (KR); Young-Han KIM, San Diego, CA (US); Lele WANG, La Jolla, CA (US); Bernd BANDEMER, San Diego, CA (US)

(73) Assignees: THE REGENTS OF THE UNIVERSITY OF CALIFORNIA, Oakland, CA (US); Electronics and Telecommunications Research Institute, Daejeon (KR)

(21) Appl. No.: 14/190,918

(22) Filed: Feb. 26, 2014

(30) Foreign Application Priority Data
Aug. 26, 2013 (KR) 10-2013-0101328

(51) Int. Cl. H04L 1/00

(52) U.S. Cl. CPC H04L 1/0054; H04L 1/0076
USPC 375/341

(57) ABSTRACT

A method and apparatus for embodying an algorithm that can simultaneously restore a present codeword and an interference codeword with low complexity so as to obtain high throughput in a wide interference signal power level are provided. By simultaneously restoring a desired codeword and an interference codeword by considering an interference signal upon decoding, high throughput performance can be obtained regardless of a power level of the interference signal.

### CROSS-REFERENCE TO RELATED APPLICATION

This application claims priority to and the benefit of Korean Patent Application No. 10-2013-0101328 filed in the Korean Intellectual Property Office on Aug. 26, 2013, the entire contents of which are incorporated herein by reference.

### BACKGROUND OF THE INVENTION

(a) Field of the Invention

The present invention relates to a method and apparatus for decoding a desired signal and an interference signal in a wireless network.

(b) Description of the Related Art

In a wireless network, a user communicating through a single broadcasting medium may interfere with communication of other users.

In this case, as a channel code reduces an influence of noise such as interference, a reliable communication method may be provided. In general, because interference of another user has been handled as a portion of noise, a system that uses a channel code minimizes a signal to interference-noise ratio (SINR). However, when power of an interference signal is strong, the method is ineffective.

A system that introduces a decoding algorithm of a successive interference cancellation method removes an influence of an interference signal by restoring and decoding a codeword from the interference signal and restores a codeword from the present signal. However, when power of an interference signal is weak, this method is ineffective.

In order to obtain high throughput in a system regardless of a power level of an interference signal, codewords of a transmitting terminal of the interference signal and a transmitting terminal of the present signal should be simultaneously decoded. A most direct method is to embody a simultaneous decoding algorithm for interference, but the method requires high complexity to integrate a probability of an interference codeword sequence, and therefore, a conventional technique included only a probability of an interference symbol.

An existing wireless communication system used a method of regarding an interference signal as noise and of decoding a desired signal or of decoding a desired signal after sequentially removing an interference signal. In such an interference processing method, there is a problem that throughput performance is deteriorated according to a power level of an interference signal.

### SUMMARY OF THE INVENTION

The present invention has been made in an effort to provide a method and apparatus for embodying an algorithm that can simultaneously restore a present codeword and an interference codeword with low complexity so as to obtain high throughput at a wide interference signal power level. The present invention has also been made in an effort to further provide a method and apparatus for embodying such simultaneous interference decoding algorithm with low complexity.

An exemplary embodiment of the present invention provides a method of decoding a sequence that is received in a receiving apparatus. The method includes: performing first decoding using the sequence, a codeword of a first transmitting signal, and a codeword of a second transmitting signal, and estimating a message of the first transmitting signal based on a performance result of the first decoding; and performing second decoding using the estimated message.

The first decoding may be performed in parallel through a plurality of components that are included in an inner decoder of the receiving apparatus.

The first decoding may follow a maximum likelihood (ML) decoding rule.

The ML decoding rule may be a joint ML decoding rule.

The first decoding may include calculating a conditional probability of the codeword of the first transmitting signal and the codeword of the second transmitting signal, when the sequence is received using the codeword of the first transmitting signal and the codeword of the second transmitting signal.

The method may further include deinterleaving the estimated message, after the estimating of a message.

Another embodiment of the present invention provides a receiving apparatus that decodes a received sequence. The receiving apparatus that decodes a received sequence includes: a first decoder that performs first decoding using the sequence, a codeword of a first transmitting signal, and a codeword of a second transmitting signal, and that estimates a message of the first transmitting signal based on a performance result of the first decoding; and a second decoder that performs second decoding using the estimated message.

The first decoder may include a plurality of components that perform the first decoding in parallel.

The first decoder may perform the first decoding according to an ML decoding rule.

The ML decoding rule may be a joint ML decoding rule.

The first decoder may calculate a conditional probability of the codeword of the first transmitting signal and the codeword of the second transmitting signal, when the sequence is received using the codeword of the first transmitting signal and the codeword of the second transmitting signal.

The receiving apparatus may further include a deinterleaver that deinterleaves the estimated message.

### BRIEF DESCRIPTION OF THE DRAWINGS

FIG. 1 is a diagram illustrating a wireless network of a plurality of users.

FIG. 2 is a diagram illustrating a transmitter and a receiver for embodying a concatenated coding architecture according to an exemplary embodiment of the present invention.

FIG. 3 is a diagram illustrating an inner decoder of a receiver according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements. Further, the terms “-er”, “-or”, “module”, and “block” described in the specification mean units for processing at least one function and operation, and can be implemented by hardware components or software components and combinations thereof.

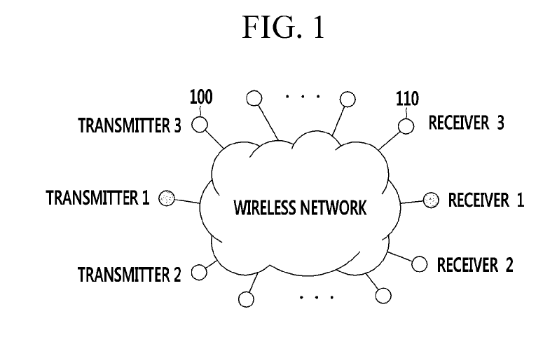

FIG. 1 is a diagram illustrating a plurality of transmitters and receivers that are included in a wireless network.

Referring to FIG. 1, a plurality of transmitters 100 and a plurality of receivers 110 are connected through a wireless networks.

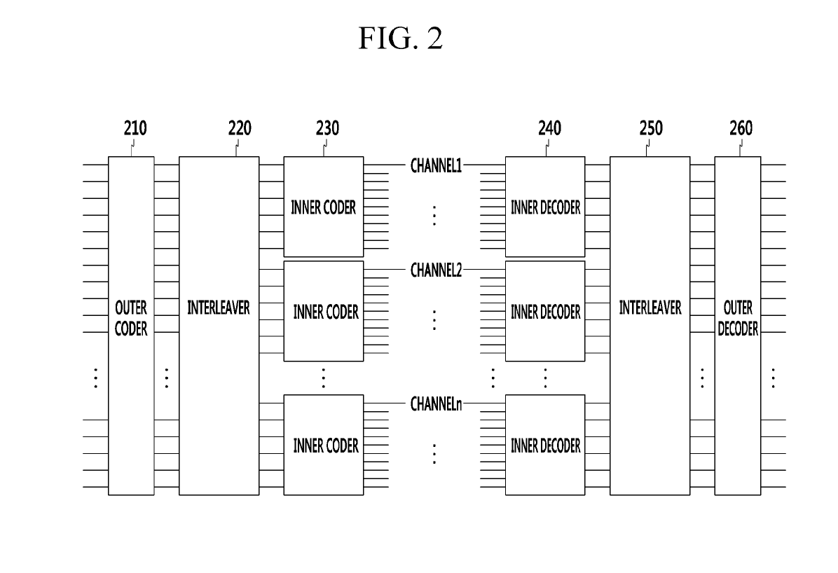

FIG. 2 illustrates a pair of a transmitter and a receiver that are connected with a wireless network.

According to an exemplary embodiment of the present invention, the transmitter 100 and the receiver 110 of FIG. 2 follow a standard concatenated coding architecture.

FIG. 2 is a diagram illustrating a transmitter and a receiver that embody a concatenated coding architecture according to an exemplary embodiment of the present invention.

Referring to FIG. 2, the number of transmission symbols used in the transmitter 100 is N, and the number of information bits thereof is K. Therefore, a data rate R becomes K/N (bits/transmission-symbol).

An outer coder 210 encodes the K number of information bits into an L number of groups, and generates an M/L number of information bits of each group. That is, the K number of information bits are coded into the M number of information bits and the rate becomes K/M.

An inner coder 230 including the L number of parallel block codes loads the M number of information bits to the N number of transmission symbols. That is, each of the L number of parallel block codes loads the M/L number of information bits to the N/L number of transmission symbols. Therefore, a final data rate of the transmitter 100 is shown in Equation 1.

$$R = \frac{M / L}{N / L} = \frac{M}{N} ( bit / transmission \text{-} symbol ) \qquad ( Equation 1 )$$

In an exemplary embodiment of the present invention, the outer coder 210 of FIG. 2 is a portion of a coder class and may become an illustration of linear block codes such as convolution/turbo codes or Reed-Solomon codes, Bose-Chaudhuri-Hocquenghem codes (BCH codes), and low-density parity check codes (LDPC codes), but the outer coder 210 is not limited thereto.

The inner coder 230 of FIG. 2 is a portion of a coder class. A length of the inner coder 230 is short as N/L, and therefore the inner coder 230 is excellent in terms of bit error rate (BER) and frame error rate (FER).

The inner coder 230 and the outer coder 210 may be connected by an M-by-M interleaver 220. In this case, the interleaver 220 has a standard structure and may be embodied to follow a regular, random, or pseudo-random method.

Because the receiver 110 has a standard concatenated coding architecture, the receiver 110 may include an inner decoder 240, a deinterleaver 250, and an outer decoder 260. In this case, the inner decoder 240 may include the L number of components.

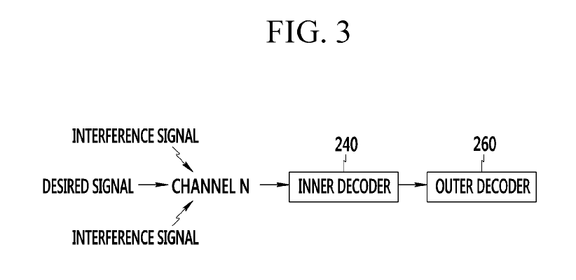

FIG. 3 is a diagram illustrating an inner decoder of a receiver according to an exemplary embodiment of the present invention.

Referring to FIG. 3, each constituent element of the inner decoder 240 according to an exemplary embodiment of the present invention has an interference signal codebook.

First, the inner decoder 240 determines codebook and channel information of a desired signal and an interference signal based on a symbol that is output from a channel.

According to an exemplary embodiment of the present invention, the inner decoder 240 may determine codebook and channel information of the signal according to an optimal maximum likelihood (ML) decoding rule. Hereinafter, an ML decoding rule will be described through Equations 2 to 5.

First, a desired message ŵ that is transmitted through an ML decoding rule may be defined by Equation 2.

$$\begin{matrix}\hat{w} = arg {max}_{w} p ( y \vert w ) \\ = arg {max}_{w} p ( y \vert x ( w ) ) \\ = arg {max}_{w} {\sum }_{{w}^{′}} p ( y \vert x ( w ) , {x}^{′} ( {w}^{′} ) )\end{matrix} \qquad ( Equation 2 )$$

Therefore, when both a signal of a desired message and a signal of an interference message are received as a channel output y, by calculating Equation 2, a message ŵ may be known. That is, according to Equation 2, a message ŵ that can maximize likelihood of a channel output sequence, which is a length N/L, may be estimated.

When calculating an ML decoding rule, a codeword of a desired signal x(w) and a codeword that is conveyed by an interference signal x′(w′) may be used.

According to an exemplary embodiment of the present invention, because the inner decoder 240 is designed with a relatively short block length N/L, an optimal ML decoding rule can be followed with lower complexity. Further, in an exemplary embodiment of the present invention, because an interference signal is simultaneously decoded, complexity of a decoding algorithm may increase, but by disposing the inner decoder 240 of a short length in parallel, overall complexity can be lowered.

An ML decoding rule according to another exemplary embodiment of the present invention may be expressed with a joint ML decoding rule. Equation 3 represents a message ŵ that is calculated with a joint ML decoding rule.

$$\hat{w} = arg {max}_{w} {max}_{{w}^{′}} p ( y \vert x ( w ) , {x}^{′} ( {w}^{′} ) ) \qquad ( Equation 3 )$$

An ML codeword tuple from the transmitter 100 and another interference transmitter may be used in Equation 3, and may follow a different decoding rule such as a simultaneous nonunique decoding rule that integrates a codebook structure of an interference signal.

Each constituent element of the inner decoder 240 may generate hard or soft information of an M/L bit according to a used outer code according to an exemplary embodiment of the present invention. For example, when a Reed-Solomon code is used as an outer code, the inner decoder 240 may output alphabet of a size 2^{M/L}.

A decoder for decoding an outer code may use a general decoding algorithm according to a given outer code, and an output sequence may be generated according to an inner code.

In an exemplary embodiment of the present invention, a receiver that is positioned at a boundary between two cells of a wireless cellular system can perform simultaneous interference decoding with lower complexity.

For example, a signal that is transmitted from an encoder of a transmitting terminal of K=512, M=768, L=64, and N=1024 in which a total code rate is ½ may be considered. In this case, an outer encoder may use a Reed-Solomon code with a code rate of ¾, and an alphabet size thereof becomes 2¹². The inner encoder is formed with 64 different inner block coders with a code rate of ⅔, and an input thereof is 12 bits and an output thereof is 18 bits. The interleaver may be randomly added at a design step of the encoder.

Thereafter, the inner decoder 240 that can use a codebook structure of an interference signal, which is a central characteristic of the present invention, receives a signal that is transmitted from the encoder.

When the inner decoder 240 decodes a signal using a codebook structure, a channel may be modeled as in Equation 4.

y=gx(w)+g′x′(w′)+z (Equation 4)

In Equation 4, x is a desired signal, x′ is an interference signal, y is a signal that is received from a channel, and z is Gaussian noise. That is, a desired signal, an interference signal, and noise from a channel are coupled, and the receiver receives an output sequence y that is output from the channel.

When a user who transmits an interference signal in an adjacent cell uses a linear block code with a code rate of ½ (input of 8 bits, output of 16 bits), each component of the inner encoder may estimate a message of a desired signal as in Equation 5.

$$\hat{w} = arg {max}_{w ∈ \{ 1 , … , {2}^{12} \}} {max}_{{w}^{′} ∈ \{ 1 , … , {2}^{8} \}} ‖ y - gx ( w ) - {g}^{′} {x}^{′} ( {w}^{′} ) ‖ \qquad ( Equation 5 )$$

In order to shorten a time that is consumed for estimating a message, each component of the inner decoder 240 may be embodied in parallel. As described above, as a component that is included in the inner decoder 240 performs operations in parallel, complexity of the ML decoding algorithm can be reduced.

In this way, according to an exemplary embodiment of the present invention, a decoding algorithm according to the present invention simultaneously restores a desired codeword and an interference codeword by considering an interference signal upon decoding, and thus high throughput performance can be obtained regardless of a power level of the interference signal. In addition, interference signals can be simultaneously decoded with lower complexity, and a high throughput performance can be obtained regardless of a power level of an interference signal.

The foregoing exemplary embodiment of the present invention describes a wireless network between two users causing interference, but the scope of the present invention is not limited thereto, and those skilled in the art will recognize that many variations of such embodiments exist. Such variations are intended to be within the scope of the present invention and the appended claims.

What is claimed is:

1. A method of decoding a sequence that is received in a receiving apparatus, the method comprising:
performing first decoding using the sequence, a codeword of a first transmitting signal, and a codeword of a second transmitting signal, and estimating a message of the first transmitting signal based on a performance result of the first decoding; and
performing second decoding using the estimated message.

2. The method of claim 1, wherein the first decoding is performed in parallel through a plurality of components that are included in an inner decoder of the receiving apparatus.

3. The method of claim 1, wherein the first decoding follows a maximum likelihood (ML) decoding rule.

4. The method of claim 3, wherein the ML decoding rule is a joint ML decoding rule.

5. The method of claim 1, wherein the first decoding comprises calculating a conditional probability of the codeword of the first transmitting signal and the codeword of the second transmitting signal using the codeword of the first transmitting signal and the codeword of the second transmitting signal, when the sequence is received.

6. The method of claim 1, further comprising deinterleaving the estimated message, after the estimating of a message.

7. A receiving apparatus that decodes a received sequence, comprising:
a first decoder that performs first decoding using the sequence, a codeword of a first transmitting signal, and a codeword of a second transmitting signal, and that estimates a message of the first transmitting signal based on a performance result of the first decoding; and
a second decoder that performs second decoding using the estimated message.

8. The receiving apparatus of claim 7, wherein the first decoder comprises a plurality of components that perform the first decoding in parallel.

9. The receiving apparatus of claim 7, wherein the first decoder performs the first decoding according to an ML decoding rule.

10. The receiving apparatus of claim 9, wherein the ML decoding rule is a joint ML decoding rule.

11. The receiving apparatus of claim 7, wherein the first decoder calculates a conditional probability of the codeword of the first transmitting signal and the codeword of the second transmitting signal using the codeword of the first transmitting signal and the codeword of the second transmitting signal, when the sequence is received.

12. The receiving apparatus of claim 7, wherein the receiving apparatus further comprises a deinterleaver that deinterleaves the estimated message.
